(19) United States
(12) Patent Application Publication
(10) Pub. No.: US 2013/0332658 A1
(43) Pub. Date: Dec. 12, 2013

(54) DATA STORAGE SYSTEM AND METHOD THEREOF

(71) Applicant: QNAP SYSTEMS, INC., New Taipei City (TW)

(72) Inventors: Chien-Hung Yang, New Taipei City (TW); Ming-Shing Su, New Taipei City (TW); Shang-Cheng Yeh, New Taipei City (TW)

(73) Assignee: QNAP SYSTEMS, INC., New Taipei City (TW)

(21) Appl. No.: 13/658,214

(22) Filed: Oct. 23, 2012

Related U.S. Application Data
(60) Provisional application No. 61/658,492, filed on Jun. 12, 2012.

(51) Int. Cl. G06F 12/00

(52) U.S. Cl. 711/103; 711/154; 711/114; 711/E12.008

(57) ABSTRACT

The present invention discloses a data storage system using a solid state disk to replace a non-volatile memory. The data storage system comprises a plurality of controllers, a first storage unit and a second storage unit. The plurality of controllers are electrically connected with each other, and are capable of storing data into said storage units and restoring data from said storage units. When a controller receives the data transmitted from a remote device, a data journal is generated and stored into the first storage unit. After a message of “successfully received” is sent back to the remote device, the data is transferred to the second storage unit.

The current application claims a priority to the U.S. provisional patent application No. 61/658,492 filed on Jun. 12, 2012.

### FIELD OF THE INVENTION

The present invention is related to a data storage system and a method thereof, more specifically to a data storage system utilizing a solid state disk as a means of temporary data storage and a method thereof.

### BACKGROUND OF THE INVENTION

The demand for storage capacity is increasing day by day because the network technology provides a convenient and easy method to get information, including data, picture, media and video streams etc. Except the demand of the storage capacity, the user has the highest expectation for the reliability of the storage. In the past, most users used the Direct-Attached-Storage (DAS) to store data and information. Although the DAS could provide a convenient storage environment to users, but it has low reliability and not easy to sharing the data stored in the storage. Recently, the storage network can provide concurrent sharing for users and more reliable storage than the DAS.

There are two schemes in the storage network, the Network Attached Storage (NAS) and Storage Area Network (SAN). A storage control apparatus for the Network Attached Storage (NAS) is configured to transfer data to/from clients by file-level, but the storage control apparatus for the Storage Area Network (SAN) transfers data to/from clients by block-level. Some schemes provide the hybrid service with file-level and block-level. Generally, the storage control apparatus transfers data to/from clients from/to the conventional disks that are organized into as a Redundant Array of Independent Disks (RAID). RAID provides super mass storage capacity and enhances the data reliability by stripping data across multiple disks, and stores a parity check information in a particular designated disk of multiple disks storage environment. But, the read-write head mechanism of the disk in the RAID makes a latency decreasing the speed performance of accessing data for users. In another situation, a storage control apparatus with a power failure decreases the access reliability. For a storage network with better performance, the largest need is to develop a more fast and reliable storage control apparatus that can promote the speed and access reliability for a storage network. In order to create a greatest access reliability storage environment, some storage control apparatus in the storage network provide a plurality of controllers, wherein, one controller can take over the service and the access of data provided by the other controller which failed down.

Thus, a technique has been proposed in the patent U.S. Pat. No. 7,730,153 B1 for taking over the operations of a failed filer. With which, all filers store all related information includes file, raid and partners information in non-volatile random access memories (NVRAM). One filer can take over from the other failed filer, and replays/writes the mirrored related information mentioned above of the failed filer stored in NVRAM to disk. After the taking over, the survival filer processes all operations directed the failed filer until the failed filer is recovered and rebooted. Accordingly, with this proposed technique, it is possible to create a more reliable storage environment than the prior art. However, with this proposed technique, the NVRAM needs a power supply to keep in a normal operation state. The power failure situation may occur in the NVRAM such as the power of one filer failed down. When the power of NVRAM failed down, all mirrored information should be erased and the “take-over” operation cannot be achieved by the survival controller.

Due to the above reason, what is needed is a data storage apparatus in the storage network that employs an alternative structure for achieving a reliable and robust storage environment in the storage network even though the power failed down.

### SUMMARY OF THE INVENTION

In view of the foregoing drawbacks, a data storage system is disclosed in the present invention, wherein the data storage system utilizes a solid state disk in replacement of the non-volatile memory. Since the data stored in the solid state disk can easily be shared by controllers active accessing, and when one of the controllers is out of function or failed, the solid state disk can remain functional and retain the data, and does not require consistently synchronization and data transfer among the controllers in such a way that the other controllers can promptly obtain the current data or data transmission logs processed by the first controller and take over the tasks of data transfer when power failure occurred.

The data storage system disclosed by the present invention includes: a plurality of controllers, a first storage unit and a second storage unit, wherein the plurality of controllers are interconnected to each other and each of which are electrically connected with the first storage unit and the second storage unit. When the controller receives data transferred from a remote device, the controller generates a data journal, which is then stored into the first storage unit. The controller sends “successfully received” message to the remote device and then the data is stored into the second storage unit.

In another embodiment of the present invention, in response to the process of data transferred from the second storage unit by the controller, the controller generates a data journal comprising an index which is transferred to the first storage unit.

In another embodiment of the present invention, the first storage unit is a solid state disk.

In another embodiment of the present invention, the second storage unit is a hard disk or a disk array.

In another embodiment of the present invention, the data journal is a compressed file or logs of data transfer.

In another embodiment of the present invention, a method for receiving transmitted data from a remote device is disclosed, which is executed in the data storage system, comprising the steps of: receiving an I/0 request sent from a remote device; receiving the transferred data from the remote device; processing the data to generate a data journal; storing the data journal into a first storage unit, and storing the data into a second storage unit for storage.

The present invention further discloses a method of resuming data transfer, in the application of data storage system, comprising the steps of: detecting a controller failed, obtaining the data journal from the first storage unit corresponding to the controller; processing the data journal to restore the data; and storing the data into a second storage unit.

A method of data movement disclosed by the present invention, applied in the data storage system, comprising the steps of: generating a data journal comprising the current address of the data; storing the data journal to a first storage unit; and transferring the data.

The method of resuming data transfer, applied in a data storage system to resume an interrupted moving, comprising the steps of: detecting a controller failed, obtaining an index and a data log from the data journal of the first storage unit corresponding to the controller; and storing the data into a second storage unit.

### BRIEF DESCRIPTION OF DRAWINGS

FIG. 1 illustrates one embodiment of the data storage system.

FIG. 2 illustrates second embodiment of the data storage system.

FIG. 3 is a flow chart of receiving data transfer from a remote device according to an embodiment of the present invention.

FIG. 4 is a flow chart of resuming data transfer according to an embodiment of the present invention.

FIG. 5 is a flow chart of data movement according to another embodiment of the present invention.

FIG. 6 is a flow chart of resuming data transfer in the situation of interrupted moving.

### DETAILED DESCRIPTION OF THE PREFERRED EMBODIMENTS

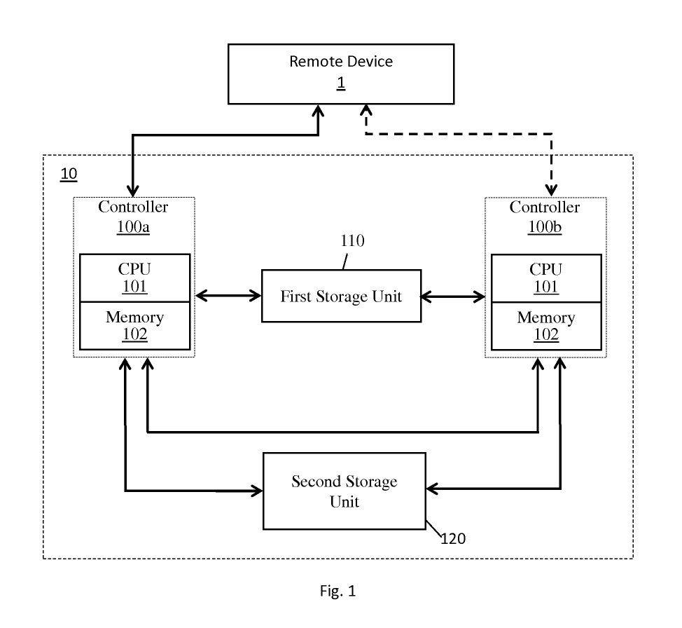

FIG. 1 illustrates one embodiment of the data storage system, in which the data storage system 10 is electrically connected with the remote device 1 for receiving data transferred from the remote device 1 or transferring data to the remote device 1.

The remote device 1 is a peripheral device which is electrically connected with the data storage system 10. The data storage system 10 is also capable of simultaneously being connected with more than one peripheral device. The data storage system 10 can be a data backup apparatus, for producing and storing backup copies of the data transferred from the remote device 1. The data storage system 10 comprises: controllers 100a, 100b; a first storage unit 110 and a second storage unit 120. The controllers 100a and 100b each has a processor 101a, 101b and a memory 102a, 102b for controlling the data flow in/out and generation of a data journal. The controller 110a and 100b are electrically connected with each other in order to monitor the function of each other to detect if any failure occurred. The data storage system 10 is electrically connected to the remote device 1 via controller 100a and/or 100b.

The controller 110b is selectively connected with the remote device 1. The data journal comprises a compressed file in accordance with the data. When the original data is lost, the compressed file is then used to restore the original data. The first storage unit 110 is used for temporary storage of the foregoing data journal and is electrically connected with the controller 100a and 100b, each of which is capable of separately storing and restoring the data from the first storage unit 110. According to an embodiment of the present invention, the first storage unit 110 is a solid state disk (SSD). Since the data stored in the solid state disk can easily be shared by controllers active accessing, and when one of the controllers is out of function or failed, the solid state disk can remain functional and retain the data, and does not require consistently synchronization and data transfer among the controllers in such a way that the other controllers can promptly obtain the current data or data transmission logs processed by the first controller and take over the tasks of data transfer when power failure occurred. The second storage unit 120 is electrically connected with the controller 100a and 100b for storing the data transferred from a peripheral device such as a remote device 1 to the data storage system 10. The controller 100a and 100b each can separately store and restore the data kept in the second storage unit 120. The second storage unit 120 can be any type of storage media, such as the following examples: solid state disk, disk array composed of a plurality of disks, or any combinations of the foregoing storage media.

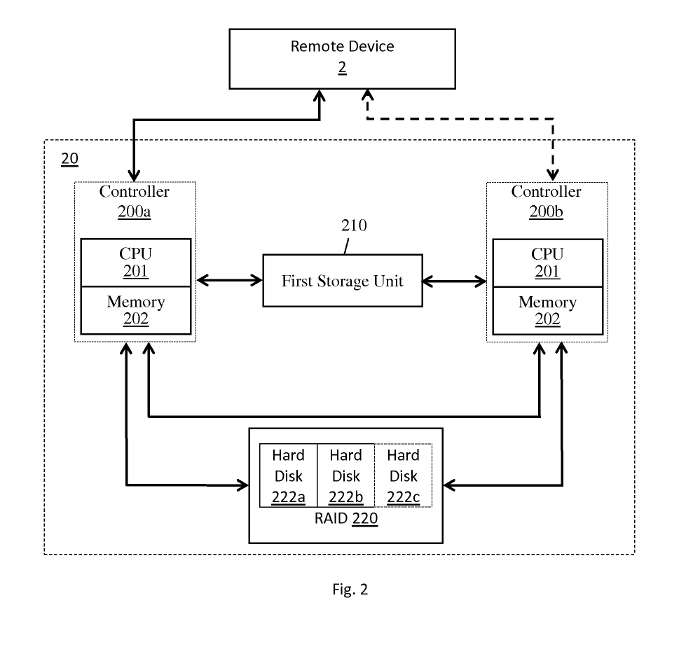

FIG. 2 illustrates second embodiment of the data storage system disclosed by the present invention, in which the data storage system 20 is electrically connected with the remote device 2 for receiving the data transferred from the remote device 2 or transferring the data to the remote device 2.

The remote device 2 is a periphery device electrically connected with the data storage system 20. The data storage system 20 is also capable of simultaneously being connected with more than one peripheral device. The data storage system 20 comprises: controllers 200a, 200b; a first storage unit 210 and a second storage unit 220. The controllers 200a and 200b each has a processor 201a, 201b and a memory 202a, 202b for controlling the data flow in/out and generation of a data journal. The disk array 220 has a plurality of disks, such as the three disks 220a, 220b, and 220c, as shown in FIG. 2. The controller 220a and 220b are electrically connected with each other to monitor the function of each other to detect if any failure occurred. The data storage system 20 is electrically connected to the remote device 2 via controller 200a and/or 200b. In the present embodiment, the data journal comprises an index of the data address in the disk array. The first storage unit 210 is for temporary storage of the foregoing data journal and electrically connected with the controller 200a and 200b, each of which can separately store and restore the data saved in the first storage unit 210. In the present embodiment of the invention, the first storage unit 110 can be a solid state disk (SSD). The disk array 220 is electrically connected with the controller 200a, 200b for storing the data transferred from the peripheral device, such as the remote device 2, to the data storage system 20. Each of controllers 200a and 200b can store and restore the data in the disk array 220.

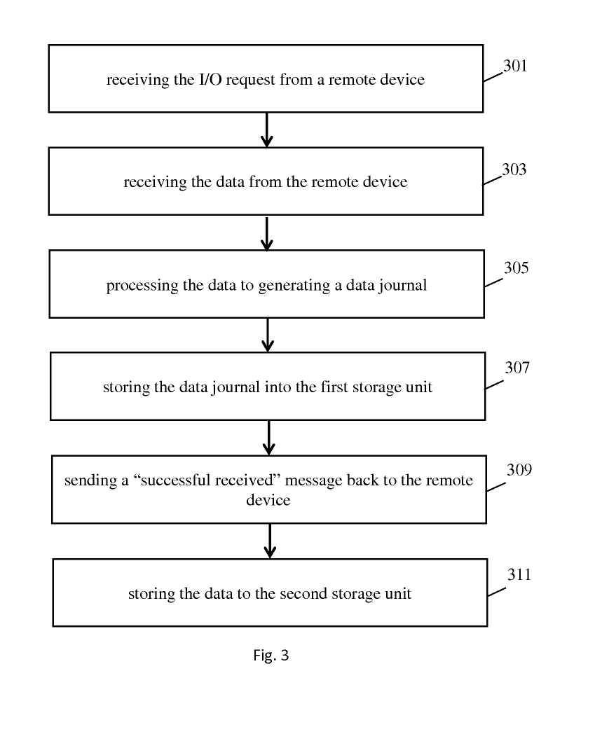

FIG. 3 is a flow chart of receiving data transfer from a remote device according to an embodiment of the present invention. As shown in FIG. 3, the method of receiving the data transferred from the remote device comprises the steps of: 1) receiving the I/O request from a remote device 301; 2) receiving the data from the remote device 303; 3) processing the data to generating a data journal 305; 4) storing the data journal into the first storage unit 307; 5) sending a “successful received” message back to the remote device 309; and 6) storing the data to the second storage unit 311. In other words, when the controller in the data storage system receives an I/O request transferred from the remote device (step 301), the controller first responds to the request from the remote device and allows the remote device to execute I/O procedure. While the remote device is transmitting the data, the controller receives the data from the remote device (step 303) and processing and compressing the data to generate a data journal (step 305) which is then written to the first storage unit (step 307). After the writing process, in order to avoid the awaiting time to be too long, the controller first sends a message to the remote device (step 309), representing the data has been successfully received. At last, the controller stores the data into the second storage unit (step 311). The process of receiving the data transferred from the remote device is completed after the data has been saved in the second storage unit.

During the process of receiving the data transferred from the remote device, when the controller has completed the step of sending the “successfully received” message to the remote device, the connection between the remote device and the data storage system might be interrupted. Any circumstances such as power failure, hardware failure, and etc. leading to the controller failed, the process of storing the data into the second storage unit as shown in step 311 could not be completed, which can undesirably cause data loss.

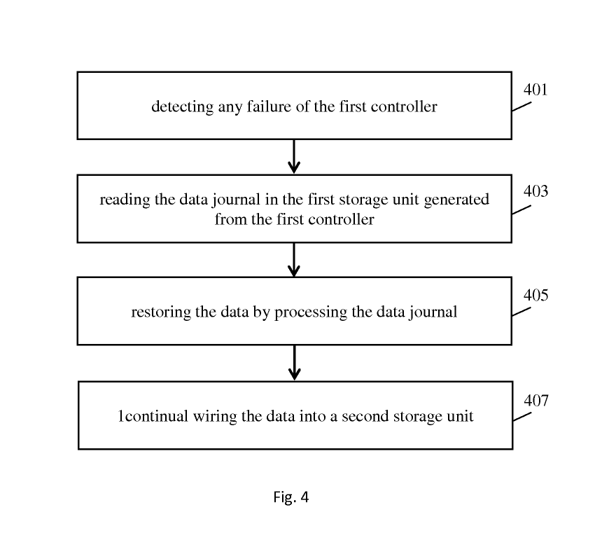

In order to avoid the foregoing situation, the present invention discloses another method of resuming data transfer. FIG. 4 is a flow chart of resuming data transfer according to an embodiment of the present invention, in which the method of resuming data transfer comprises: 1) step 401 of detecting any failure of the first controller; 2) step 403 of reading the data journal in the first storage unit generated from the first controller; 3) step 405 of restoring the data by processing the data journal; and 4) step 407 of continual wiring the data into a second storage unit. Since the plurality of controllers communicates each other at a fixed period/frequency via transferring messages to each other, even a failure is detected from a controller (step 401), another controller can immediately read the data journal stored in the first storage unit (step 403), and restore the data by processing the data journal (step 405). The data journal is a compressed data which is smaller in size compared to the original data and the original data is restored via processing the compressed data journal. The data journal also comprises a log of the transferred data, to further understand the breaking point of the transfer, so as to allow the data to be written into a second storage unit (step 407).

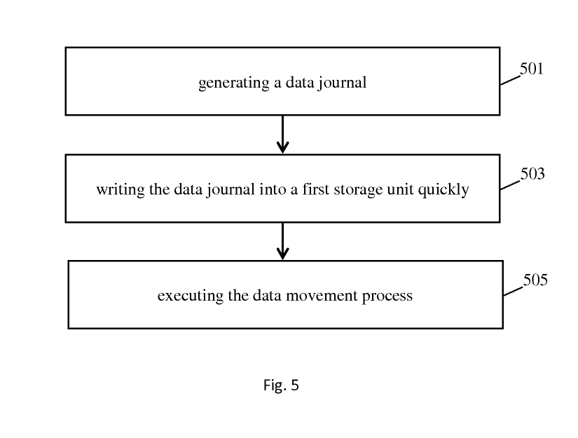

Apart from the method of receiving the data transferred from the remote device, the present invention also discloses a method of data movement in the data storage system. Data movement is executed in, but not limited to, situations such as hard disk expansion or hard disk replacement when the data need to be moved. FIG. 5 is a flow chart of data movement according to another embodiment of the present invention. As shown in FIG. 5, the method of data movement comprises: 1) step 501 of generating a data journal; 2) step 503 of writing the data journal into a first storage unit; and 3) step 505 of executing the data movement process. Before the process of data movement, the controller first generates a data journal according to the addresses of the data and the data journal constantly is renewed according to the current addresses of the data, allowing the controller to have all the addresses of the data at any instances (step 501). In other words, the index of data addresses contained in the data journal is used to direct the movement of data to avoid any errors in searching the data. The first storage unit is a solid state disk, which is fast and stable to keep data permanently. Therefore after the data journal is generated by the controller, the controller writes the data journal into the first storage unit quickly (step 503), to avoid any kind of errors where data could not be found due to power failure in the process of data movement. After the controller generates the index and writes to the first storage unit, the process of data movement is then executed by the controller (step 505).

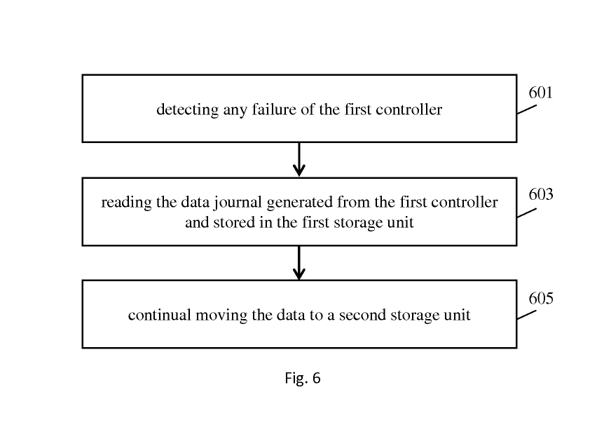

The present invention also discloses a method of resuming data transfer executed in the data storage system, to avoid loss of data due to unexpected power failure causing the controller to lose function. FIG. 6 is a flow chart of resuming data transfer in the situation of interrupted moving. As shown in the drawing, the method comprises: 1) step 601 of detecting any failure of the first controller; 2) step 603 of reading the data journal generated from the first controller and stored in the first storage unit; 3) step 605 of continual moving the data in a second storage unit 605 according to the data journal. Since the plurality of controllers communicates each other at a fixed period/frequency via transferring messages to each other, therefore even a failure is detected from a controller (step 601), another controller can immediately read the data journal from the first storage unit, wherein the data journal includes the index stored by the controller which has lost the function (603), and via the data journal to know the current allocation of the data and obtain the breakpoint of the data movement, so as to take over the unfinished job of the controller, i.e. to continually move the data to the second storage unit (605).

In summary, the present invention discloses a data storage system and a method carried out in the data storage system, allowing a plurality of controllers not to simultaneously syncing the data and the corresponding data journal, such that other controller can take over the transfer mission when a loss of function occurred in the original controller. Various modifications can be readily made by those skilled in the art. Therefore, the invention in its broader aspects is not limited to the specific details and representative embodiments shown herein. Accordingly, various modifications may be made without departing from the spirit and scope of the general inventive concept as defined by the appended claims and their equivalents.

What is claimed is:

1. A data storage system, comprising:
a first storage unit, having a non-volatile memory;
a second storage unit;
a first controller, electrically connected with the first storage unit and the second storage unit; and
a second controller, electrically connected with the first controller, the first storage unit and the second storage unit;
wherein the first controller is used to generate a data journal, which is saved in the first storage unit; the second controller is capable of detecting the condition of the first controller.

2. The data storage system according to claim 1, wherein the first storage unit is a solid state disk.

3. The data storage system according to claim 1, wherein the second storage unit is a disk or a disk array.

4. The data storage system according to claim 1, wherein the first controller receives data from a remote device, and the data journal comprises a compressed file or a transfer log of said data.

5. The data storage system according to claim 4, wherein the second controller is capable of accessing the data journal and storing the data into the second storage unit according to the data journal.

6. The data storage system according to claim 1, wherein the data journal comprises an index of data addresses.

7. The data storage system according to claim 6, wherein the second controller is capable of accessing the data journal and executing the process of data movement according to the data journal.

8. A method of receiving the data transferred from a remote device, executed in a data storage system having a first controller and a second controller detecting the condition of the first controller, comprising:
the first controller receiving an I/O requests from a remote device;
the first controller receiving the data transferred from the remote device;
the first controller generating a data journal according the data;
the first controller storing the data journal into a first storage unit; and
the first controller storing the data into a second storage unit.

9. The method of claim 8, wherein after the first controller stores the data journal into the first storage unit, a message is sent back to the remote device to notify that the data is successfully received.

10. The method of claim 9, wherein the first storage unit is a solid state disk.

11. The method of claim 10, wherein after the first controller sends the message to the remote device, if the second controller detects the first controller failed, the second controller will read the data journal saved in the first storage unit, and the data is restored according to the data journal and then stored in the second storage unit.

12. A method of data movement, executed in a data storage system having a first controller, a second controller detecting the condition of the first controller, a first storage unit and a second storage unit, comprising:
the first controller generating a data journal comprising the index of current data allocation according to the data stored in the second storage unit;
the first controller storing the data journal into the first storage unit; and
the first controller executing the process of data movement to the second storage unit.

13. The method of claim 12, wherein the first storage unit is a solid state disk.

14. The method of claim 12, wherein if the second controller detects the first controller failed, the second controller will access the data journal saved in the first storage device, and continue executing the data movement in the second storage unit according to the data journal.
